(19) United States
(12) Patent Application Publication
(10) Pub. No.: US 2013/0322055 A1
(43) Pub. Date: Dec. 5, 2013

(54) LIGHT SOURCE DEVICE AND PROJECTOR

(71) Applicant: NICHIA CORPORATION, Anan-shi (JP)

(72) Inventor: Takafumi SUGIYAMA, Yoshinogawa-shi (JP)

(73) Assignee: NICHIA CORPORATION, Anan-shi (JP)

(21) Appl. No.: 13/903,029

(22) Filed: May 28, 2013

(30) Foreign Application Priority Data
May 30, 2012 (JP) 2012-123247

(51) Int. Cl. F21V 9/00

(52) U.S. Cl. CPC F21V 9/00
USPC 362/84

(57) ABSTRACT

A light source device includes a first light source, a wavelength converter including a fluorescent material, a light-controller. The light-controller is disposed in a path of light propagating from the first light source toward the wavelength converter. The light-controller switches between transmission and reflection of light from the first light source.

### CROSS-REFERENCE TO RELATED APPLICATIONS

The present application claims priority under 35 U.S.C. §119 to Japanese Patent Application No. 2012-123247, filed May 30, 2012. The contents of this application are incorporated herein by reference in their entirety.

### BACKGROUND OF THE INVENTION

1. Field of the Invention

The present invention relates to a light source device and a projector.

2. Discussion of the Background

For a light source device used in a projector, a technology has been disclosed in which a light source for emitting blue light and a fluorescent material are used to extract blue light and green light (for example, JP 2011-133784 A). JP 2011-133784 A describes a fluorescent light emitting device which includes a light source to emit blue light, and a fluorescent wheel having a fluorescent material region where a fluorescent material to be excited by the light from the light source to emit light of predetermined wavelength is disposed.

### SUMMARY OF THE INVENTION

According to one aspect of the present invention, a light source device includes a first light source, a wavelength converter including a fluorescent material, and a light-controller. The light-controller is disposed in a path of light propagating from the first light source toward the wavelength converter. The light-controller switches between transmission and reflection of light from the first light source.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a top view of a light source device according to an embodiment.

FIG. 2 is a plan view of a wavelength converting device according to an embodiment.

FIG. 3 is a cross-sectional view of the wavelength converting device taken along a line III-III of FIG. 2.

FIG. 4 is a top view showing an inner structure of a projector according to an embodiment.

### DESCRIPTION OF THE EMBODIMENT

An embodiment for implementing a light source device and projector according to the present invention will be described below with reference to the drawings. The embodiment shown below is intended as illustrative to give a concrete form to technical ideas of the present invention, and the scope of the invention is not limited to those described below. The sizes and the arrangement relationships of the members in each of drawings are occasionally shown exaggerated for ease of explanation. In the description below, the same designations or the same reference numerals denote the same or like members and duplicative descriptions will be appropriately omitted.

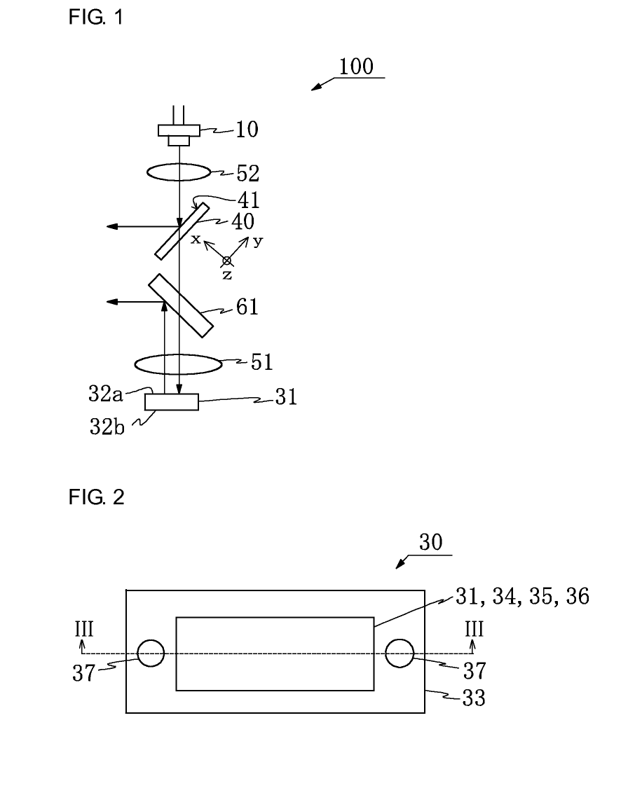

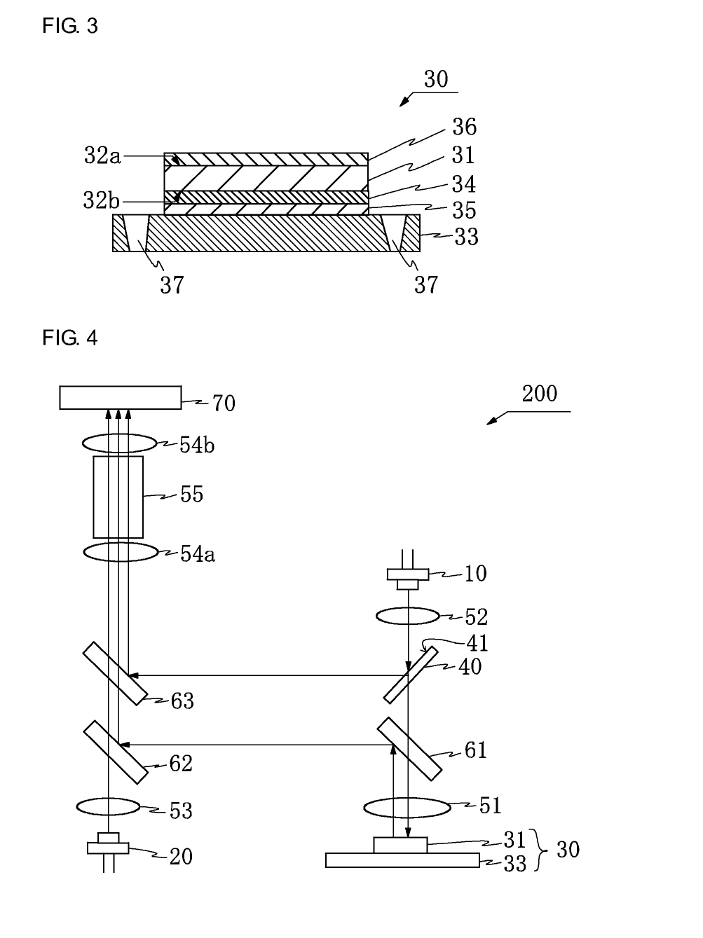

FIG. 1 is a top view of a light source device 100 according to the present embodiment. FIG. 2 is a plan view of a light source device 30 according to the present embodiment. FIG. 3 is a cross-sectional view of the wavelength converting device taken along a line III-III of FIG. 2. In FIG. 1, a side surface of the wavelength converting member 31 (the wavelength converter) is arranged facing the upper surface of the light source device 100.

As shown in FIG. 1, the light source device 100 includes a first light source 10, a wavelength converting member 31 including a fluorescent material, and a light-controlling member 40 (light-controller) which is arranged on the path of light which propagates from the first light source 10 toward the wavelength converting member and 31 which is configured to switch between transmission and reflection of light from the first light source 10.

With this arrangement, light from the first light source 10 is converted into two kinds of light components having different wavelength (that is, light having a same wavelength as the first light source 10 and light whose wavelength has been converted by the wavelength converting member 31). Temporally switching the transmission and reflection of the light by the light controlling member 40 enables temporally switching the light of two different wavelengths to be emitted from the light source device 100. With the configuration described above, the performance of the device can be maintained for a long period of time.

That is, as shown in FIG. 1, the propagating path of light which is emitted from the first light source 10 and reaches the light controlling member 40 can be changed by the light controlling member 40. In the case where the light from the first light source 10 is reflected by the light controlling member 40, light of the same wavelength as the light from the first light source 10 is reflected. On the other hand, in the case where the light from the first light source 10 is transmitted through the light controlling member 40, the transmitted light reaches the wavelength converting member 31 and is converted into light having a different wavelength than that of the first light source 10, and then is released to outside. Accordingly, with the light from the first light source 10, light of two different wavelengths can be obtained alternately.

In the light source device 100, there is no necessity of the wavelength converting member 31 containing a fluorescent material to be driven by a motor, so that operation can be maintained for a long period of time compared to the case using a motor-driven fluorescent wheel.

Now, each component of the light source device 100 will be described below.

### (Light Source)

For the first light source 10, a long-life light source is preferable, and for example, a semiconductor laser diode or a light emitting diode (LED) can be used. Particularly, a semiconductor laser element has a narrower emission angle compared to that of an LED, and therefore optical loss at a lens or the like can be reduced. Further, the light source device 100 of the present embodiment emits light with an emission spectrum having a very narrow width, the use of the light source device 100 as the light source of a projector can expand the color reproducibility. In order to excite the wavelength converting member 31 to be described later, the first light source 10 to emit light having a peak emission spectrum of 400 nm to 480 nm is preferably used. In the examples to be described later, a semiconductor laser element which emits blue light is used as the first light source 10. With this arrangement, with the use of the light from the first light source 10, green light of high output power can be obtained from the wavelength converting member 31 to be described later. Thus, high output power can be obtained from both the two kinds of light (blue light and green light) from the light source device 100.

Only one first light source 10 is arranged in FIG. 1, but a plurality of first light sources may be arranged to improve the output of the light source device 100.

The second light source 20 is to compensate the color of light among three colors (red, blue, and green) necessary in the use of a projector which is unobtainable by the light source device 100. In an example to be described later, the light emitted from the first light source is blue and the wavelength converted light is green, so that a semiconductor laser element to emit red light is used as the second light source. Having the light source device 100 and the second light source 20 enables high output power three colors of light and thus can be used as a light source of a projector. In the light source device 100 the light of two different wavelengths can be temporally switched, so that appropriately adjusting the ON/OFF timing of the first light source 10 and the second light source 20 enables temporally switching of the colors of the light, for example, red→blue→green→red→blue, and so on. With this arrangement, in the case where a DMD (Digital Mirror Device) which will be described later is used as a projection element 70 for projecting images, light is emitted by the DMD in a temporal sequence, for example, red→blue→green→red→blue, and so on. Thus, a high-quality white light can be exhibited as projected light.

### (Wavelength Converting Member)

The wavelength converting member 31 includes a fluorescent material to be excited by light from the first light source 10 and to emit a wavelength converted light. In an example to be described later, a fluorescent material to be excited by light from the first light source and to emit light in a range of green light to yellow light with a wavelength of 500 to 600 nm is used. Examples of the fluorescent material which satisfies such conditions include Lu₃Al₅O₁₂:Ce and Y₃Al₅O₁₂:Ce. The wavelength converting member 31 may be made singly of a fluorescent material, or may be a mixture of a fluorescent material and a binder. The binder made of an inorganic material is less subject to discoloration compared to that made of a resin even when the light from the first light source is irradiated for a long period of time, so that reduction in output can be prevented. With this arrangement, the operable life of the wavelength converting member 31 can be extended.

For the wavelength converting member 31, as shown in FIG. 1, a wavelength converting member 31 may be used singly, or as shown in FIG. 2, a wavelength converting device 30 which includes a heat sink 33, a reflective layer 34, and an antireflection layer 36 may be used to substitute for the wavelength converting member 31. The wavelength converting device 30 is not limited to that which includes all the members described above, and members described above can be selectively used. For example, in the case where the wavelength converting device 30 is made up of a wavelength converting member 31 and a heat sink 33, and the heat sink 33 is made of a material having heat dissipating property and light reflectivity, the number of members forming the wavelength converting device 30 can be reduced which can reduce production cost. Also, other members may also be included.

For example, a submount may be disposed (not shown) between the wavelength converting member 31 and the heat sink 33 to reduce the difference in linear expansion coefficient between the wavelength converting member 31 and the heat sink 33. It is preferable that the linear expansion coefficient of the submount is larger than that of the wavelength converting member 31 and smaller than that of the heat sink. With this arrangement, generation of cracks in the wavelength converting member 31 which has a small linear expansion coefficient can be prevented. Employing a material such as carbon, AlN, SiC, diamond, and GaN having a good thermal conductivity for the submount enables good dissipation of heat generated in the wavelength converting member 31.

The wavelength converting member 31 includes, as shown in FIG. 3, a first main surface 32a and a second main surface 32b on an opposite side to the first main surface 32a. The light from the first light source 10 is irradiated on the first surface 32a side and the heat sink 33 can be bonded to the second main surface 32b side. With this arrangement, even if the fluorescent material is excited by the light from the first light source 10 and generates heat, the heat can be released to the heat sink 33 side. Thus, deterioration of the wavelength converting member 31 can be prevented and performance of the light source device 100 can be maintained for a long period of time. The wavelength converting member 31 preferably has a plate-like body. This arrangement allows an increase in the contact area with the heat sink 33, so that heat generated in the wavelength converting member 31 can be efficiently released to the heat sink 33. As shown in FIG. 3, arranging the heat sink 33 with a width larger than that of the wavelength converting member 31 allows the heat to be released more efficiently.

The wavelength converting member 31 preferably has a thickness of 0.01 mm to 1 mm. With this arrangement, heat generated in the wavelength converting member 31 can be released efficiently. Further, in the case where the wavelength converting member 31 has a thickness of 0.05 mm to 0.3 mm, in addition to the effect described above, light extracting efficiency can also be enhanced.

The material of the heat sink 33 is needed to have a high heat dissipating property, and examples thereof include copper, a copper alloy, aluminum, and iron. Further, in order to prevent corrosion, a plating treatment may be applied. In an example to be described later, copper is used. Copper has a high thermal conductivity, so that swift release of heat generated in the wavelength converting member 31 can be achieved. Copper is also resistance to corrosion, so that the performance can be maintained for a long period of time.

Also, as shown in FIG. 3, at the second main surface 32b side of the wavelength converting member 31, a reflective layer 34 can be disposed between the second main surface 32b and the heat sink 33. With the reflective layer 34, the light emitted from the wavelength converting member 31 toward the second main surface 32b side can be reflected to the first main surface 32a side. In the arrangement described above, it is preferable that the wavelength converting member 31 and the heat sink 33 are respectively bonded to the corresponding sides of the reflective layer 34. With this arrangement, heat from the wavelength converting member 31 can be released to the heat sink 33 via the reflective layer 34, so that light emitted from the wavelength converting member 31 toward the second surface 32b side can be efficiently reflected to the first main surface 32a side without reducing the heat dissipation by the heat sink 33. Thus, improvement in the light output to the first main surface 32a side and the heat dissipation by the heat sink can be both improved.

The reflective layer 34 is preferably made of a material which can reflect light from the light source 10 and wavelength converted light by the wavelength converting member 31. Examples of thereof include a metal such as Ag, Al, Au, and Rh having a high reflectivity to such light, or a dielectric multi layer made of a combination of SiO₂, Al₂O₂, AlN, ZrO₂, TiO₂, and/or Nb₂O₅etc. The reflective layer 34 may be made of stacked layers of two or more kinds of materials described above. For example, Al₂O₃ layer and Ag layer are disposed in this order from the second main surface 32b side of the wavelength converting member 31. With this construction, a part of light released from the wavelength converting member 31 toward the second main surface 32b side can be totally reflected at the Al₂O₃ layer, and light which is not reflected at the Al₂O₃ layer can be reflected at the Ag layer in a reliable manner. Thus, optical output of the first main surface 32a side can be improved.

As shown in FIG. 3, the wavelength converting member 31 is preferably bonded to the heat sink 33 via a bonding layer 35. With this arrangement, heat generated in the wavelength converting member 31 can be swiftly release to the heat sink 33 side compared with the case where the wavelength converting member 31 and the heat sink 33 are spaced apart from each other. Examples of the bonding layer include a metal layer such as a Au—Sn layer and a Au layer. In the case where the reflective layer 34 is disposed on the wavelength converting member 31, it is preferable that the reflective layer 34 and the heat sink 33 are bonded via the bonding layer 35. With this arrangement, a better bonding can be obtained compared to the case where the wavelength converting member 31 and the bonding layer 35 are directly bonded.

Also, as shown in FIG. 3, an antireflection protective layer 36 may be disposed on the first main surface 32a side of the wavelength converting member 31 to protect the wavelength converting member 31 and to improve light extracting efficiency from the first main surface 32a side. Examples of the material for the antireflection protective layer 36 include SiO₂.

Also, as shown in FIG. 2 or FIG. 3, one or more threaded holes 37 may be formed in the heat sink 33 so that the wavelength converting device 30 is threadably fixed.

In the wavelength converting member 31, the first main surface 32a is, as shown in FIG. 4, arranged perpendicular to the incident light from the first light source 10. With this arrangement, both the light reaches to the wavelength converting member 31 and light emitted from the wavelength converting member 31 can be converted into collimated light by a single collimator lens. Thus, a need of disposing collimator lenses respectively converting light reaches the wavelength converting member 31 and light emitted from the wavelength converting member 31 into parallel light can be eliminated, so that the number of the members can be reduced and which allows a reduction in the production cost. The wavelength converting member 31 can be disposed so that the first main surface 31a is at an angle with respect to the direction of light from the first light source 10. The light from the first light source 10 is irradiated on the first main surface of the wavelength converting member 31 at an angle. Thus, the irradiated area can be increased compared to the case where the light is emitted perpendicular to the first main surface. With this arrangement, the density of light irradiated on the wavelength converting member 31 can be reduced and stress applied on the wavelength converting member 31 can be reduced.

### (Light-Controlling Member 40)

The light-controlling member 40 is for switching between transmission and reflection of light from the first light source 10. The light-controlling member 40 is, as shown in FIG. 1, disposed on the path of light propagating from the first light source 10 toward the wavelength converting member 31.

Examples of the light-controlling member 40 include a wheel and a shutter. In the case where a wheel is employed, an opening region for transmitting light is formed in a part of the wheel and the wheel is rotated around the x-axis shown in FIG. 1. With this arrangement, the wheel is configured such that while the wheel is rotating, when the light from the first light source hits the wheel, the light is reflected and when the light from the first light source hits the opening region of the wheel, the light is allowed to pass through. In the case where a shutter for controlling the reflection/transmission of light is employed, the shutter may be slid in the y-direction or the z-direction in FIG. 1, or the end portion of one side may be fixed to slide the shutter in a reciprocating manner in the y-z plane. With this, while the shutter is in operation, when light from the first light source reaches the shutter, in the case where the path of light is blocked by the shutter, the light is reflected and in the case where the path of light is not blocked by the shutter, the light is allowed to pass through. Also for the light-controlling member 40, a liquid crystal member for electrically controlling the reflection/transmission of light can be used. In this case, reflection or transmission of light from the first light source 10 can be switched by the presence or absence of applied voltage to the liquid crystal member. That is, when the voltage is not applied to the liquid crystal member, the light from the first light source 10 is allowed to pass through, and when the voltage is applied to the liquid crystal member, the light from the first light source 10 is reflected. In an example to be described later, a liquid crystal member is used. The liquid crystal member is for electrically controlling the reflection/transmission of light, so that a desired function can be maintained for a long period of time compared to the members such as a shutter and a wheel which are mechanically controlled.

In the light-controlling member 40, the light reflecting surface 41 for reflecting light from the first light source 10 may be formed by forming the light-controlling member 40 with a material having a high reflectance or by separately disposing a material having a high reflectance to the wavelength of the light from the first light source 10 on the light-controlling member 40. In the case where the first light source has a wavelength in a range of 400 to 460 nm, a material having a high reflectivity such as Ag or Al may be employed.

As shown in FIG. 1, the light-reflecting surface 41 of the light-controlling member 40 is preferably arranged at an angle with respect to the direction of the light incident from the light source 10. With this arrangement, light reflected at the light-controlling member 40 can be extracted without being overlapping with the light incident to the light-controlling member 40. In the case where the reflecting surface 41 of the light-controlling member 40 is arranged perpendicular to the direction of the incident light from the light source, there is a need to dispose a member for transmitting light incident on the light-controlling member 40 and reflecting light to change the propagation direction of the light reflected by the light-controlling member. But the arrangement described above does not need to dispose the member, so that the number of members can be reduced. As a member for performing both transmission and reflection of light, a dichroic mirror is known, but in the present embodiment, the light incident to the light-controlling member 40 and the light reflected at the light-controlling member 40 have a same wavelength, and thus, a dichroic mirror can not be used. For this reason, a structural component which does not need such a member, that is, the light reflecting surface 41 of the light-controlling member 40 is preferably arranged at an angle to the direction of light incident from the light source 10.

Hereinafter, the components constituting the projector 200 which are other than that described above will be described.

### (Collimator Lens 51, 52, 53)

The collimator lens 51 is for converting light emitted from the wavelength converting member 31 into parallel light. The light emitted from the wavelength converting member 31 is spread over a certain angle, so that the collimator lens 51 is preferably disposed at a position close to the wavelength converting member 31. With this arrangement, the light is condensed by the collimator lens 51 before spreading too widely, which can eliminate a need of a lens having a large diameter and thus both downsizing of the light source device 100 and a reduction of cost can be achieved. With a conventional fluorescent wheel, a blur occurs in a perpendicular direction with respect to the plane of rotation when the wheel rotates, so that it is difficult to arrange a collimator lens near the fluorescent material disposed on the wheel. On the other hand, according to the present embodiment, the wavelength converting member 31 provided with a fluorescent material can be fixedly arranged, so that the collimator lens 51 can be arranged closer to the wavelength converting member 31. The emission from the first light source 10 and the second light source 20 are also spread with a certain angle, so that as shown in FIG. 1 or FIG. 4, a collimator lens (52, 53) can be respectively arranged at the emission side of the first light source 10 and the second light source 20.

Examples of the material of the collimator lens include a resin and glass. In the case where light of a short wavelength, for example, a light of wavelength in a range of 400 to 480 nm is used as the light source, glass which has a higher resistivity to light of short wavelength than that of a resin is preferable.

In FIG. 1, one collimator lens is arranged with respect to each of the members of the first light source 10, the second light source 20 and the wavelength converting member 31, but a plural of collimator lenses can be arranged with respect to a single member. If high precision parallel light is to obtain by using a single collimator lens, a very complicated shape is necessary, but arranging a plurality of collimator lenses having a simple shapes in an overlapping manner, a collimated light can be obtained.

### (Dichroic Mirror 61, 62, 63)

The dichroic mirrors 61, 62, and 63 are respectively configured to be transparent to specific light and to reflect other light in predetermined directions respectively

Appropriately arranging the dichroic mirrors 61, 62, 63 allows, as shown in FIG. 4, the light emitted from each member of the first light source 10, the second light source 20, and the wavelength converting member 31 to collimate and to propagates to the projecting element 70 to be explained later.

### (Projection Element 70)

The projection element 70 is for using a light incident from the first light source 10, and a second light source 20, and a wavelength converting member 31 to create a predetermined image. Examples of projection element 70 include LCOS (Liquid Crystal on Silicon) and DMD (Digital Mirror Device).

### EXAMPLE

Hereinafter, an example of the present invention will be described with reference to FIG. 4. FIG. 4 is a top view of a projector according to an embodiment. In FIG. 4, the wavelength converting member 31 and the heat sink 33 are shown and other members are omitted in the wavelength converting device 30.

Blue light emitted from the first light source 10 is collimated by the collimator lens 52 and then is reflected at the light-controlling member 40 in a perpendicular direction. Then, the light is reflected at the dichroic mirror 63 to propagate to the projection element 70 side.

On the other hand, the blue light emitted from the first light source 10 and is transmitted at the light-controlling member 40 is transmitted through the dichroic mirror 61 and then is emitted to the first main surface 32a side of the wavelength converting device 30. The wavelength converting device 30 absorbs the blue light and emits green light to the first main surface 32a side. The green light thus emitted is collimated by the collimator lens 51 and is reflected in a perpendicular direction at the dichroic mirror 61. Then, the light is reflected at the dichroic mirror 62 and is transmitted through the dichroic mirror 63 to propagate to the projection element 70 side.

The red light emitted from the second light source 20 is collimated by the collimator lens 52, then is transmitted through the dichroic mirrors 62, 63 to propagate to the projection element 70 side.

The three colors (red, blue, green) of light propagates to the projection element 70 side pass through a meniscus lens 54a to enter a rod integrator 55. The light passes through the rod integrator 55 to obtain a uniform intensity distribution of light, then via the meniscus lens 54b propagates to the projection element 70.

Using a DMD as the projecting element 70, a red light, a blue light, and a green light are irradiated on the DMD at different timing to produce projected image.

Obviously, numerous modifications and variations of the present invention are possible in light of the above teachings. It is therefore to be understood that within the scope of the appended claims, the invention may be practiced otherwise than as specifically described herein.

What is claimed is:

1. A light source device comprising:
a first light source;
a wavelength converter comprising a fluorescent material;
a light-controller disposed in a path of light propagating from the first light source toward the wavelength converter, the light-controller switching between transmission and reflection of light from the first light source.

2. The light source device according to claim 1, wherein the wavelength converter has a first main surface and a second main surface at an opposite side from the first main surface, light from the first light source is irradiated on the first main surface side, and a heat sink is bonded at the second main surface side.

3. The light source device according to claim 1, wherein the light-controller includes a light-reflecting surface arranged obliquely with respect to a direction of incident light from the first light source.

4. The light source device according to claim 1, wherein the first light source comprises a semiconductor laser element to emit blue light.

5. The light source device according to claim 4, wherein the fluorescent material is excited by light from the first light source and emits green light.

6. The light source device according to claim 1, wherein the light-controller includes a liquid crystal member.

7. The light source device according to claim 1, wherein light emitted from the wavelength converter is extracted through a lens as parallel light.

8. A projector comprising the light source device according to claim 1 and a second light source.
